(19) United States
(12) Patent Application Publication
(10) Pub. No.: US 2008/0071611 A1
(43) Pub. Date: Mar. 20, 2008

(54) Parking meter payment by cell phone link

(76) Inventor: Robert Lovett, Finger, TN (US)

Correspondence Address: JAMES RICHARDS, 58 BONING RD, FAYETTEVILLE, TN, 37334, US

(21) Appl. No.: 11/520,991

(22) Filed: Sep. 14, 2006

(51) Int. Cl. G07B 15/00

(52) U.S. Cl. 705/13

(57) ABSTRACT

A system and method for activating a parking meter by utilizing a cell phone. An account is established with the parking authority, and the cell phone is used to contact the parking authority, identify the meter and service desired, obtain a code, and enter the code in the meter to initiate the service. In one embodiment, the code is generated using a time dependent encrypted clock method. In one embodiment, the parking meter may communicate with the cell phone on a wireless link to start or stop the meter, the wireless link may be BLUETOOTH®, ZIGBEE®, infrared, or other short range wireless link. An in-car meter embodiment is also described.

### BACKGROUND

1. Field of the Invention

The present invention pertains generally to the field of parking meters, and more particularly to the field of payment systems for parking meters.

2. Background of the Invention

Parking meters are traditionally configured to receive cash in the form of coins or bills, such as dollar bills. However, in today's world of checks, credit cards and other forms of plastic money, one does not usually have a pocket full of quarters for the parking meter and must often make a special trip to a local merchant to obtain a few coins for parking. This takes extra time for the driver and the merchant, adds aggravation, and tends to make one avoid metered parking whenever possible.

Furthermore, in some areas, parking rates are high enough that regular parking requires a large number of quarters and frequent trips to the meter. Some parking meters now take five and ten dollar bills and may accumulate enough money to attract thieves that saw off the whole meter late at night to get the cash, generating damage far in excess of the theft.

Systems are beginning to be available to address these problems by providing a smart card payment method whereby a digital card is inserted into the meter and fees are deducted from the card. Typically, one must obtain a special card, creating new issues and problems regarding the obtaining and funding of the card.

Therefore, there is a need for systems and methods for more convenient and secure payment methods for parking meters and related devices.

### BRIEF DESCRIPTION OF THE INVENTION

Briefly, the present invention relates to a system and method for activating a parking meter by utilizing a cell phone. An account is established with the parking authority, and the cell phone is used to contact the parking authority, identify the meter and service desired, obtain a code, and enter the code in the meter to initiate the service. In one embodiment, the code is generated using a time dependent encrypted clock method.

In one embodiment, the parking meter may communicate with the cell phone on a wireless link to start or stop the meter, the wireless link may be BLUETOOTH®, ZIGBEE® infrared, or other short range wireless link.

In one embodiment, an in-car meter may be used. The in-car meter includes a display, keypad and clock and may include a wireless transceiver. A patron calls the parking authority, identifies the parking space or lot, receives a code, and enters the code in the in-car meter. The in-car meter displays a valid in-use display.

The account may be a credit card account or other account. Billing may be monthly, by accumulated balance, or by each transaction, or by pay in advance. Municipal authorities may add the bill to a resident's water or other utility bill.

These and further benefits and features of the present invention are herein described in detail with reference to exemplary embodiments in accordance with the invention.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 shows an exemplary parking meter in accordance with the present invention.

FIG. 2A shows the meter on a pole with a telephone number posted on the pole.

FIG. 2B is a schematic diagram for the parking meter of FIG. 1.

FIG. 2C is a system diagram including a cell phone and an authorization server.

FIG. 3 illustrates an exemplary code table for use with the parking meter of FIG. 1.

FIG. 4 illustrates code sequence generation using the code wheel.

FIG. 5 illustrates how code time is updated using the code table of FIG. 3.

FIG. 6 illustrates a set of codes for delivering multiple products or services.

FIG. 7 illustrates an exemplary method for distributing phone numbers to parking meters within the range of a particular cell tower.

FIG. 8 shows an exemplary list of installed parking meters with associated locations.

FIG. 9 shows a layout of installed meters with instructions on how to find a parking space.

FIGS. 10A-10E illustrate an exemplary sequence of cell phone screens for parking using the meter in accordance with the present invention.

FIGS. 11A-11E show a sequence of cell phone displays near the end of the parking time.

FIGS. 12A-12E show a sequence of cell phone displays for finding an empty parking space.

FIGS. 13A-13E illustrate a sequence using a wireless link to the meter.

FIGS. 14A-14E show various information that may be displayed relating to parking using the present invention.

FIG. 15 illustrates the use of an in-car parking meter in accordance with the present invention.

FIG. 16 shows a view of the in-car personal parking meter with the remaining parking time displayed.

FIG. 17 is a rear view of the in-car personal parking meter showing battery installation and activation instructions.

### DETAILED DESCRIPTION OF THE INVENTION

The present invention relates to a system and method for operating a parking meter or related device which may be operated using information communicated over a cell phone or Personal Digital Assistant (also referred to as a PDA) or other device which includes a cell phone. The system requires no cash or coins or credit cards or other special cards at the meter location. The cell phone is used to access a server which provides a code for the product or service desired and bills an account set up with the server. The parking meter does not need to be connected by phone line or power line or otherwise to be activated. Thus, the meter may utilize low cost simple installation and may fit into existing meter mounts without requiring the tearing up of sidewalk or pavement to install a new phone line or other communication interconnect. The meter does not need a special card reader or credit card reader or other complex device and thus may be very simple and reliable. A further advantage of the simple design is that it may consume very little power, allowing extended run times on a battery and potentially allowing the meter to run on solar power.

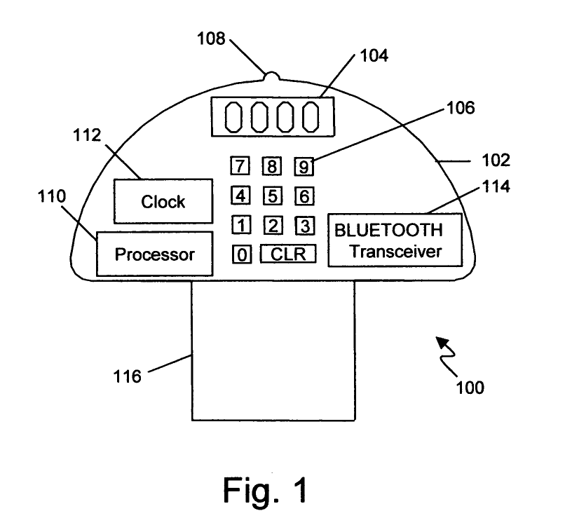

FIG. 1 shows an exemplary parking meter 100 in accordance with the present invention. The parking meter 100 of FIG. 1 may provide a number of services related to parking time. Referring to FIG. 1, the parking meter 100 comprises a display 104 for showing the time remaining, a keypad 106 for entering an enabling code, a processor 110 for processing the enabling code and running the meter display 104, and a clock 112. The parking meter 100 also may include a wireless interface 114 for communicating various information to and from the meter 100 including entering the enabling code. In one embodiment, the parking meter has no keypad 106 and all communication is via the wireless interface 114 (also referred to as wireless transceiver). In another embodiment, the parking meter has no wireless interface 114 and all communication is via the keypad 106. In still another embodiment, both the keypad 106 and wireless interface 114 are included. The meter 100 may also include one or more light emitting diodes (LED's) 108 to indicate status such as valid and expired time. The meter is enclosed in a meter housing 102, which includes a mounting flange 116.

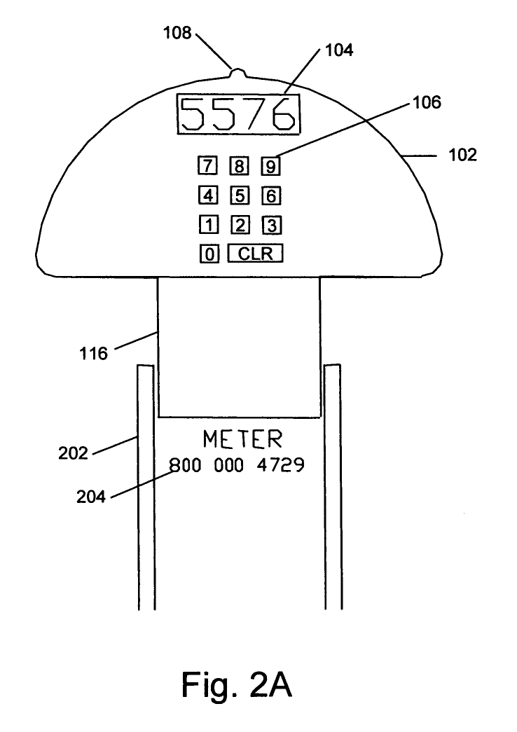

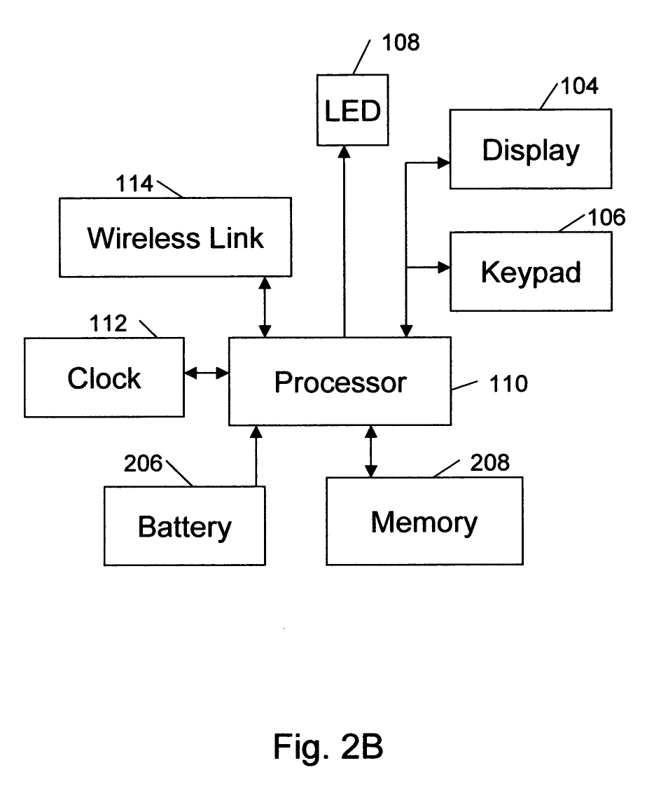

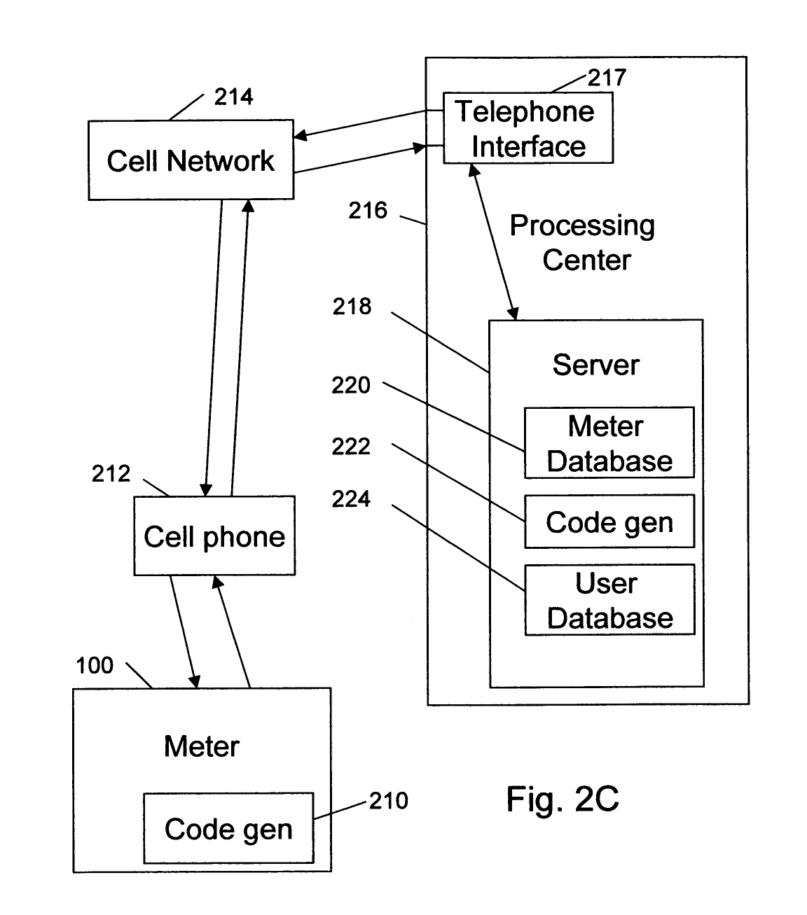

FIG. 2A shows the meter 100 on a pole 202 with a telephone number 204 posted on the pole 202. In one embodiment, the telephone number 204 may be from a block of telephone numbers and the telephone number 204 may identify the particular meter being used. In another embodiment, a meter identification number is a separate number (not shown) posted with the telephone number 204 on the pole 202, on the meter 100 or generally near the meter. The meter identification number may be an alphanumeric string including letters, symbols, or punctuation as well as numeric characters.

FIG. 2B is a schematic diagram for the parking meter of FIG. 1. Referring to FIG. 2B, the parking meter comprises a processor 110 connected to a display 104 for displaying the parking time, a keypad 106 (optional) for entering the enabling code, a battery 206 and memory 208, a clock 112 for determining the parking time and for use with coding, and a wireless link 114 (optional) for communicating enabling the enabling code, meter identification, and other data as desired or necessary for the particular application. The meter 100 also may include one or more light emitting diodes 108, (LED's) (optional) for indicating status. The processor receives inputs from the keypad 106 or wireless link 114 and generates a code to be compared with the enabling code provided through either the keypad 106 or wireless link 114. When a match is found, the parking time is displayed on the display 104. The processor 110 may flash the LED 108 for warnings or to indicate overtime parking as described below.

FIG. 2C is a system diagram including a cell phone and an authorization server (also referred to as a central server, or server). Referring to FIG. 2C, the system comprises a meter 100, including a code generator 210 (typically a function of the processor of FIG. 2B), a processing center 216 having a central server 218 with a matching code generator 222. The server 218 is connected over a telephone interface 217 to a communication network (including a cell phone network 214) for requesting an enabling code and delivering the code to the meter 100. In one embodiment, a system user (alternatively referred to as a patron) serves as the communication link between the cell phone 212 and the meter 100 by entering the parking meter identification 204 printed on the meter into the cell phone 212, and by entering the resulting enabling code shown on the cell phone display into the meter 100 using the keypad 106. In another embodiment, the wireless link 114 provides the communication between the cell phone 212 and the meter 100.

The operation of the system is flexible allowing code entry using the keypad 106 or wireless interface 114, depending on the hardware available in the meter 100 and the cell phone 212.

For operation with the keypad 106, a user calls the number 204 indicated, preferably using the cell phone 212, and contacts the central server 218. The user may then provide the meter number. The meter number may be entered using the keypad or by speaking, if voice recognition is implemented in the server. The central server 218 then computes an enabling code based on the meter number and provides the enabling code to the user via the cell phone 212. As shown, the enabling code is four digits. The user enters the four digit enabling code into the meter 100 using the keypad 106 and the meter 100 generates a corresponding internal code. If the meter internal code value and entered values agree, the meter 100 shows a valid display 104 and begins tiring the parking time. The parking time will typically be the maximum allowed for that location, for example two hours. Upon returning to the car, the user may call again and receive a second number for turning off the meter 100. When the meter 100 is turned off, the user's account in the user database 224 will be billed for the time used. If the user does not turn off the meter, the account will be billed for the full time. In one embodiment, the user must read a validation code from the meter and communicate that code to the server to turn off the billing.

If the user drives off without turning off the meter, the meter will continue to show time left and a second user may use that time, as is common practice with current coin operated meters. A second user, calling from a different phone linked to a different account may add time to the meter, if desired. The second user, however, may not turn off the meter (terminate the parking time). This would prevent a second party from generating a violation for the first user by turning off the meter while the car is still parked in the space.

One embodiment of the parking meter may include a wireless interface 114 for communicating with the cell phone 212. A number of types of wireless interfaces are typically used with cell phones including infrared, Bluetooth, WIFI and others. Bluetooth is becoming popular and is expected to be widely used in the future. In accordance with the present invention, any wireless interface which is in use now with cell phones or becomes popular in the future may be used with the present invention. One skilled in the art should be able to adapt a popular well known wireless interface to perform the functions of the present invention.

The wireless interface 114 may be used to enter the enabling code and/or to read the meter identification code (ID) so that the cell phone may send the meter ID code to the central server 218 and the server 218 may communicate the enabling code to the meter 100 without human intervention. Thus, the process of starting the parking meter may be fully automated once initiated by the user.

For operation using the wireless interface 114, the user parks the car and calls the number posted on the meter 100. Cell phone software then will link to the meter 100 and receive the meter identification number from the meter 100. The meter identification number is then sent to the central server 218. The central server 218 then finds the meter and associated code generation information in the server meter database 220, generates 222 the enabling code using the code generation information and provides the enabling code through the server telephone interface 214 to the cell phone 212. The cell phone 212 may then deliver the enabling code to the meter 100 over the wireless interface 114 automatically.

A further advantage of the wireless interface is that the meter may report meter health, battery level, tampering attempts or other information back to the server. Not only is the wireless interface more automated, requiring less operator action and inviting less operator error, the wireless interface may be made more secure by using longer enabling code numbers, longer meter ID numbers and/or more secure protocols.

One advantage of the electronic billing is that multiple levels of overtime charges and violations may be issued. For example, a one hour meter may charge $1.00 for the first hour. For thirty minutes beyond the hour, the charge may be $3.00. For the next 30 minutes, the charge may be $5.00. After the second 30 minutes in violation, a cell phone ticket may be issued for $25.00. As a further advantage, the automated ticketing process will save time and expense for the parking enforcement authority.

One embodiment of the meter may include LED's 108, which may be used to indicate parking status, such as valid time or violation. For example, a Green LED may be shown to indicate valid parking time. An Orange LED may be used to indicate a minor violation, such as the first or second thirty minutes overtime as described above, and a flashing Red LED may be used to indicate that the overtime ticket is issued.

The processing center may also include a user database 224 and may bill the user for parking time. In order to park using the system, the user must first establish an account with the processing center. Accounts may include credit card accounts, other credit accounts, pay in advance accounts, or accounts that are tied to existing utility accounts or other accounts. Billing for parking may occur after each parking event or the processing center may accumulate parking time for a period, for example one month, before billing the user. When the user calls the processing center, the call may automatically be linked to the account by using the caller ID feature and associating the cell phone number with the account. Linking the cell phone number with the account enables the elimination of the step of entering an account number, thus saving time and effort for the user. An account number may be required where the cell provider or user blocks the caller ID. As a further optional security feature, a PIN number or password may be required by some systems.

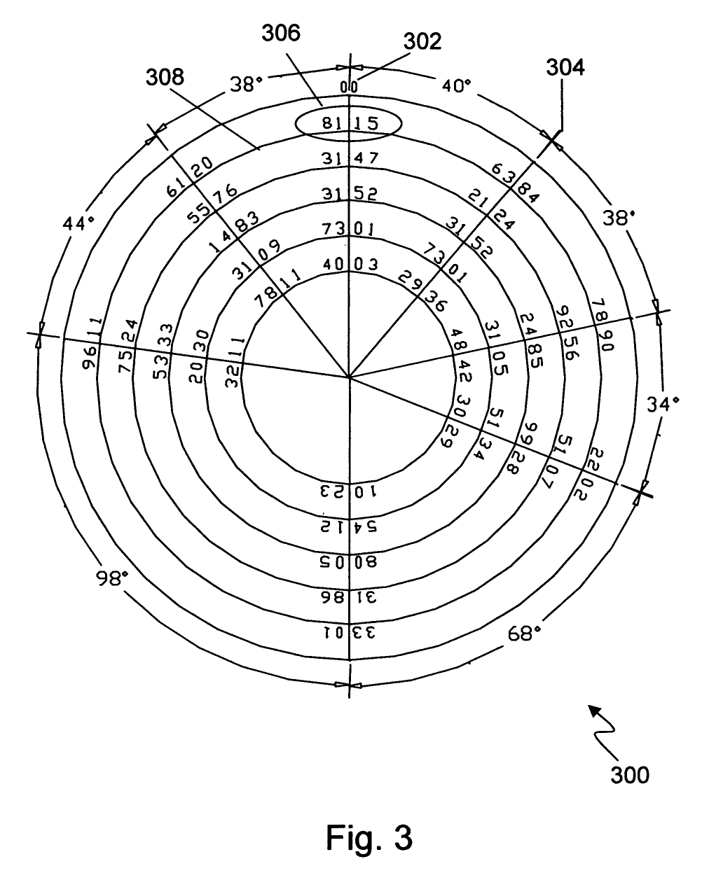

FIG. 3 illustrates an exemplary code table for use with the parking meter of FIG. 1. A number of codes may be suitable for use with the present invention. One purpose of the code is to prevent unauthorized use and allow authorized use of the parking meter. Thus, the code should not be easily predictable from past performance or from other meters. The code should change from use to use at the same meter and should be different at different meters. One method of changing the code is to include time as one of the code parameters. Other methods may be used as are known in the art. Any code meeting the basic requirements may be used with the present invention. One such code is now described with reference to FIG. 3. The table of FIG. 3 is shown as a round table 300, also referred to as a wheel, to illustrate the cyclic nature of the code. The code of FIG. 3 provides an encrypted time value that is updated every minute and changes every minute. The coded time value starts at a known start time 302, which is synchronized with the time of the server so that the server may generate an identical sequence of coded time values. Each meter may start at a different time and/or may use a different table, resulting in a different sequence of coded time values. The server will know the start time and table values for each meter and thus may generate a coded time value for any given meter at any given time.

Referring to FIG. 3, the table actually has 360 entries per revolution, one entry per degree. Each one-degree increment has a four digit code associated with the increment. Seven exemplary values of the 360 values are shown at the seven radial lines 304. The code for each radial 304 is shown as the four digit value 306 at each radial. Five circles 308 are shown for generating five different code sequences. Each different code sequence may be used for a different meter service. The use of different code sequences for different services will be discussed later.

Four digits are preferably used for the enabling code that is entered using the keypad. More digits may be used, but become difficult to remember and enter. Fewer digits may be used, but fewer digits allow a greater probability of a random entry match. Even with four digits some people may be tempted to enter four digits at random to see if they accidentally match and start the meter without calling in and getting charged for the time. This practice can be discouraged by flashing a warning when a wrong number is entered and disabling further entry for a timeout period of, for example, one minute, after the third wrong number is entered. Thus, it would take many hours of entering numbers to achieve a 50% chance of getting free parking—not an economically viable activity, and the perpetrator would likely attract attention in the process. Further, the system may include a map of all parking spaces logged into the server. The map may be available to the traffic police in their patrol cars, or to anyone looking for an available parking space. If a car is found with valid time on the meter and not logged in, a heavy fine may be imposed.

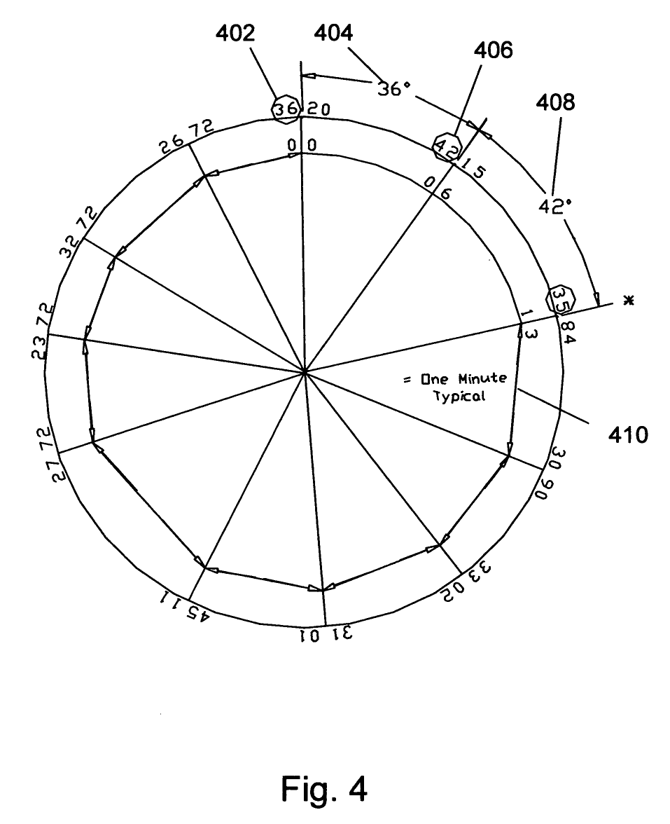

The operation of the code wheel table will now be discussed with reference to FIG. 4. FIG. 4 illustrates code sequence generation using the code wheel. Referring to FIG. 4, an initial code value is selected at random upon startup of the meter. The code value selected along with the startup time is reported to the server so that the server code may match the meter code. The server also has a copy of the code table in the meter. Alternatively, at start up, the server may download all of this information to the meter over the wireless link or a hard wired connection. (not shown). Other techniques differing in detail may be used to synchronize the server and meter at startup.

The meter changes the code value periodically. For this example, the code changes once each minute 410. At the end of each minute, the first two digits 402 of the code value are used to increment the code position on the code wheel. Referring to FIG. 4 the code value at position 00 is 3620. The first two digits 402 at code position 00 are 36, thus the code position is advanced 36 positions 404 to position 36, and the new code value is 4215. The next increment 406 is thus 42. At the end of the next minute, the code position is advanced 42 positions 408 to position 78 where the code value is 3584 and so on for each subsequent minute. The server may maintain a similar clock or calculation to generate the enabling code.

The code values for each ring may be derived by generating random or pseudorandom numbers. It is preferable that the same code value is not listed twice on the same meter. For systems with more than one code ring, the code values found on one ring should not be found on another ring to prevent ambiguity in identification of services. It is preferable that each meter have a different code table; although it is possible to operate all meters on the same code table and use a different start time for each meter. When generating code tables, it may be found that not all numbers are used when the code cycles through the wheel. This should not be a problem as long as enough numbers are used to prevent frequent occurrences of repeat code values.

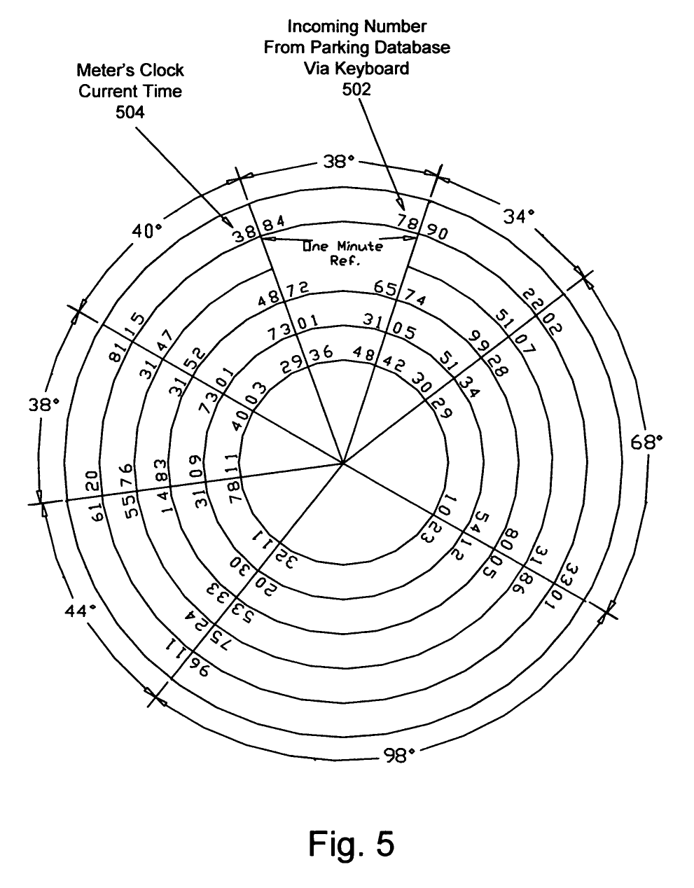

FIG. 5 illustrates how code time is updated using the code table of FIG. 3. Code time, i.e., the time clock in the meter from which the code is generated, may drift over time relative to the server time, since the meters are typically isolated, or unconnected to a common source which may regularly update time. Referring to FIG. 5, if the incoming enabling code number 502 differs from the meter current code number 504, but equals the code number for a minute earlier or later 502 (or two minutes earlier or later), the meter may accept the code and may change the meter clock to agree with the time implied by the incoming enabling code 502. Alternatively, several incoming code differences in the same direction may be required to illicit a change in the meter clock, or a small change may be made in the direction of the difference.

Alternatively, in a meter having a wireless interface, the server may send a time value along with each code value. The time value may be used to match the associated code value and may be used to reset the meter clock for use with future code values entered via the keypad from cell phones not having a wireless interface.

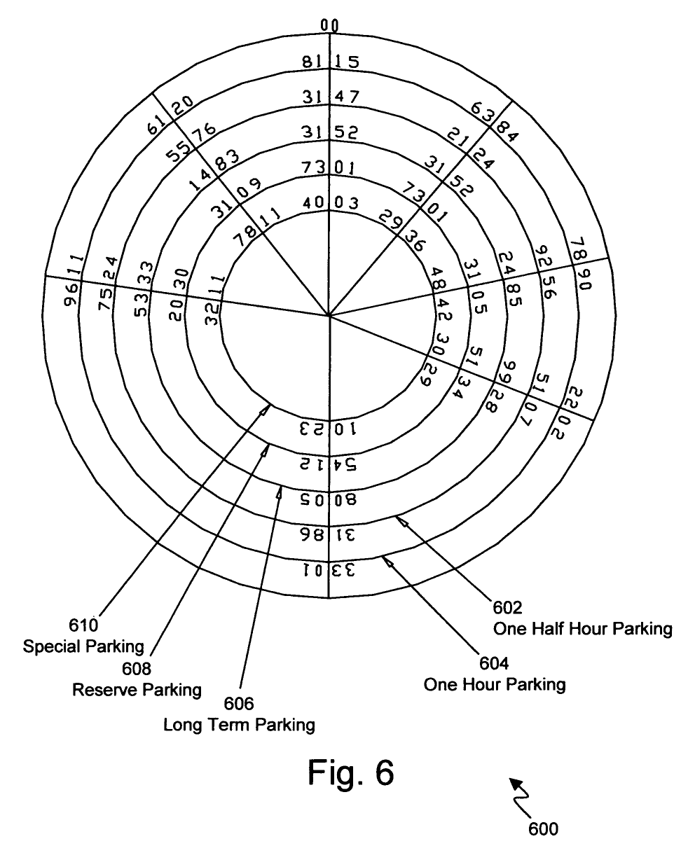

FIG. 6 illustrates a set of codes for delivering multiple services. Referring to FIG. 6, five rings are shown. Each ring has 360 entries, one for each degree. Seven of the 360 radials are shown for illustration purposes. Note that the entries for each radial and each ring are different. The five rings may be used to generate five different code sequences. In FIG. 6, the five exemplary services available are:
1) one half hour parking 602,
2) one hour parking 604,
3) long term parking 606,
4) reserve parking 608, and
5) special parking 610.

When a user calls and identifies the meter, the user may also identify the service requested. The server then generates a code for that service according to the code ring for that service. When the meter receives the enabling code, the code will match for the desired service and the meter will then provide the desired parking time service. For example, for the one half hour parking 602, the meter will display 30 minutes and count down from 30 minutes. For one hour parking 604, the meter will count down from 60 minutes. For long term parking 606, the meter will display “Long Term” and bill according to the long term rate when the parking is completed, and accordingly for reserve parking 608 and special parking 610.

In one embodiment, the telephone number may include information identifying the meter, i.e., a block of numbers may be allocated for parking meter use and the specific number identifies a specific parking meter. The block of numbers may be reused where other information, such as cell tower coverage can be used to resolve the ambiguity between two instances of the same number. In another embodiment, a meter number may be posted on the meter and entered after calling the telephone number.

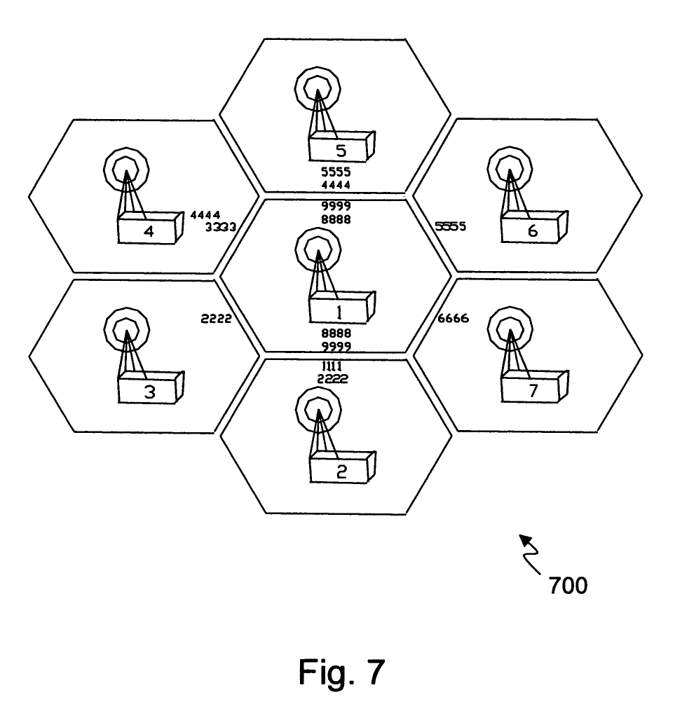

FIG. 7 illustrates an exemplary arrangement 700 for distributing phone numbers to parking meters within the range of a particular cell tower. In the embodiment of FIG. 7, a block of 10,000 phone numbers, preferably 800 numbers with the least significant four digits set aside (800 nnn-0000 to 800 nnn-9999) for parking meter use. Each phone number is assigned to a single parking meter within the range of a particular cell tower. The phone numbers may be reused in adjacent cell towers coverage area. The server will interrogate which cell tower is receiving the call and identify the meter within that cell tower coverage range. Referring to FIG. 7, the numbers are arranged with the high value 9999 digits at the cell boundary and decreasing as the meters are closer to the cell tower.

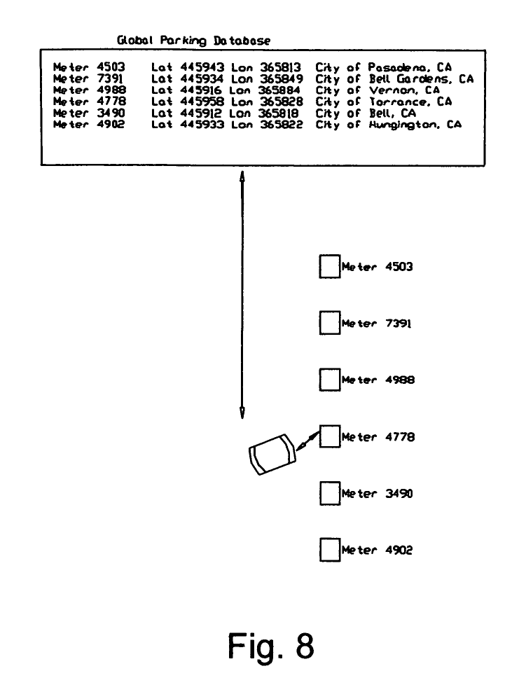

FIG. 8 shows an exemplary list of installed parking meters with associated locations. The latitude and longitude are shown for each meter as well as the owner of the meter. The server facility may be provided by a contractor operating meters for several cities. The association of each meter with the associated city allows collection of taxes to be appropriately allocated.

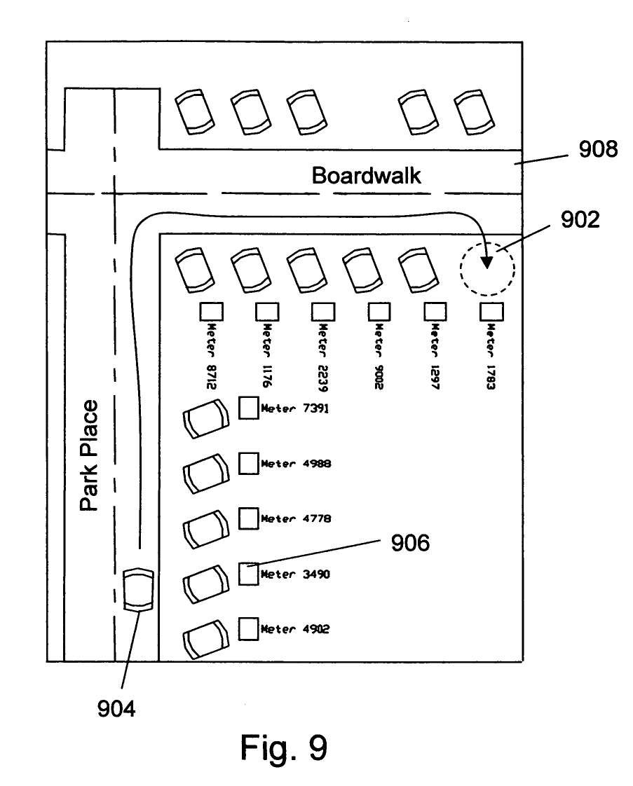

FIG. 9 shows a layout of installed meters as an aid in locating an empty parking space. FIG. 9 represents a screen image that may be displayed showing parking spaces occupied and one empty parking space. The streets 908 are labeled so that one can navigate to the empty parking space 902. A driver in a vehicle 904 contacts the server, and the wireless transceiver contacts the nearest meter 906 to determine its meter number. The server then determines the car 904 position and gives directions to the nearest empty parking space 902. The screen image of FIG. 9 may be displayed on the user's cell phone or PDA and may also be available to anyone on the Internet or to the local traffic police.

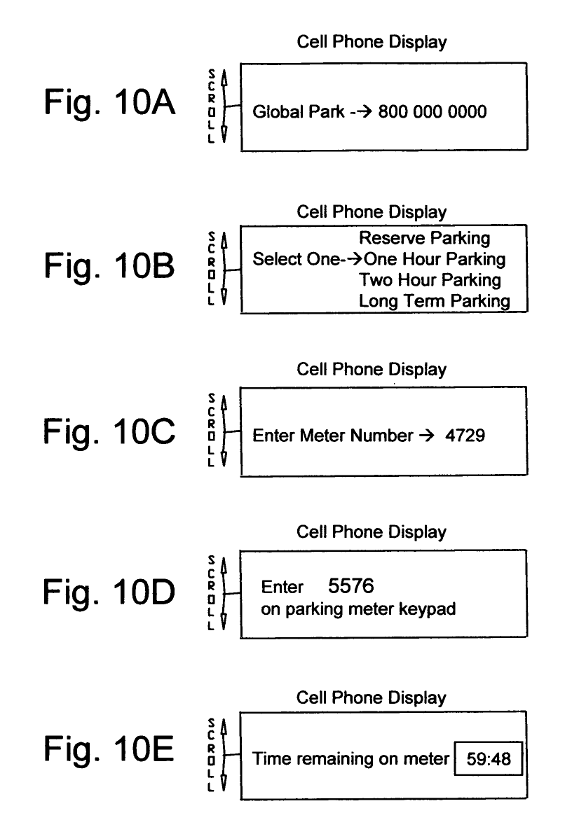

FIGS. 10A-10E illustrate an exemplary sequence of cell phone screens for parking using the meter in accordance with the present invention. FIG. 10A shows the cell phone calling the number printed on the meter. FIG. 10B shows the user selecting one hour parking. FIG. 10C shows the user entering the meter number. FIG. 10D shows the resulting enabling code to be entered into the meter using the keypad. FIG. 10E shows a display on the cell phone indicating time left. The meter will also display the same remaining time. The cell phone or PDA may run an application to provide features such as displaying remaining time or finding parking spaces. Alternatively, a web site may be used to provide this information to the user.

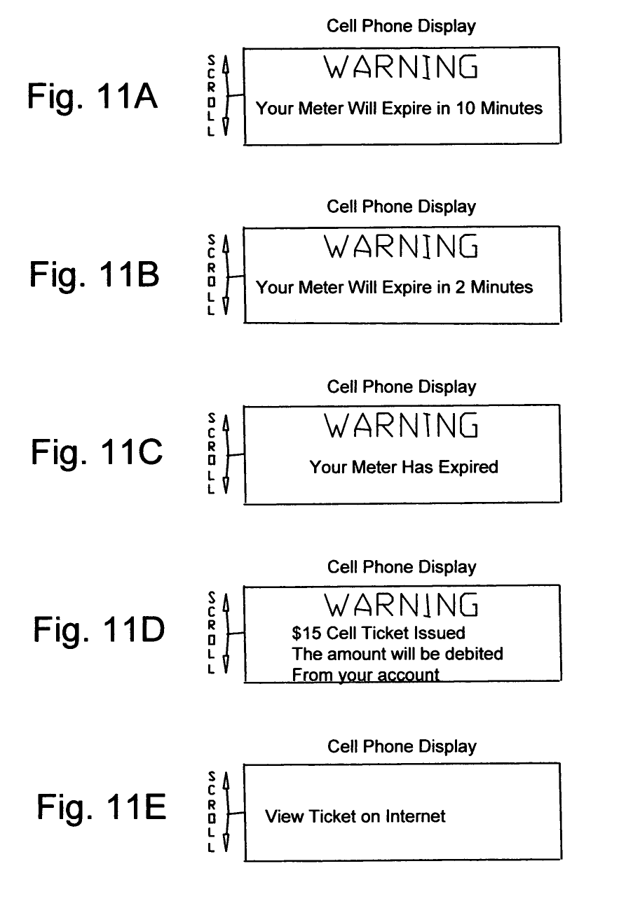

FIGS. 11A-11E show a sequence of cell phone displays near the end of the parking time. Referring to the figures, FIG. 11A shows a warning on the cell phone or PDA that the meter time will expire in 10 minutes. FIG. 11B shows a warning that the meter time will expire in 2 minutes. FIG. 11C shows a warning that the meter time has expired. FIG. 11D notifies the user that a ticket has been issued. FIG. 11E allows the user to view ticket details.

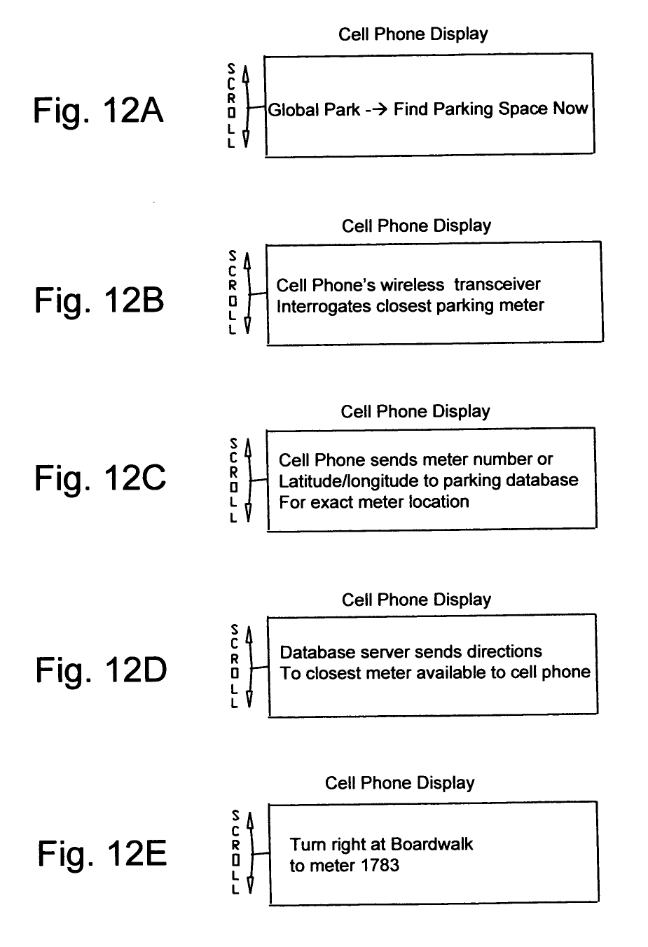

FIGS. 12A-12E show a sequence of cell phone displays for finding an empty parking space. Referring to the figures, FIG. 12A shows a user selecting the function of finding a parking space. FIG. 12B shows the cell phone interrogating the closest parking meter. FIG. 12C shows the cell phone sending the meter number or position to the parking server. (A cell phone may also include a Global Positioning Satellite (GPS) system receiver to determine position, or the cell system may have the capability to determine position). FIG. 12D shows the parking server sending directions to the closest empty parking space to the user. FIG. 12E shows the directions being displayed to the user. This sequence is shown graphically in FIG. 9.

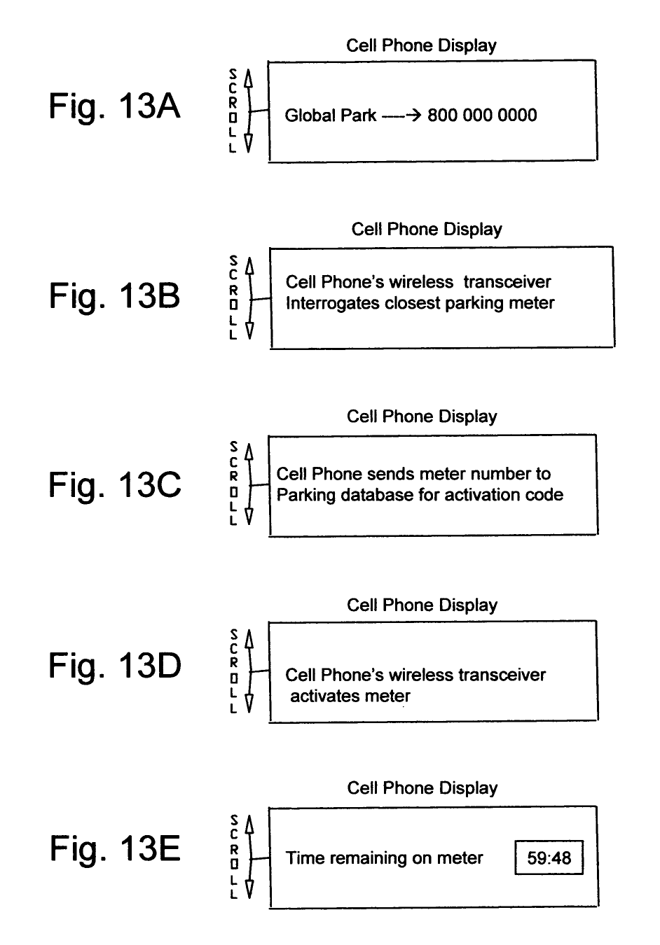

FIGS. 13A-13E illustrate a sequence using a wireless link to the meter. Referring to the figures, FIG. 13A shows the user calling the 800 number printed on the meter. FIG. 13B shows the cell phones wireless transceiver linking with and interrogating the closest parking meter. FIG. 13C shows the cell phone sending the meter number to the parking server and receiving the enabling (activation) code for the meter. FIG. 13D shows the cell phone sending the enabling code to the meter over the wireless interface to start the parking time. FIG. 13E shows the cell phone display showing the remaining parking time. The meter will also show the same remaining parking time.

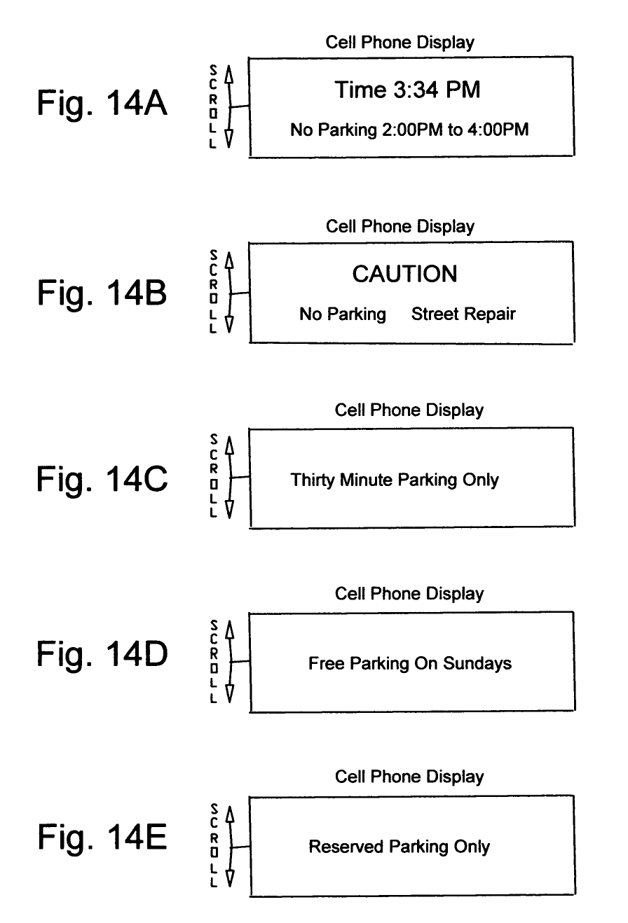

FIGS. 14A-14E show various information that may be displayed relating to parking using the present invention. Referring to the figures, FIG. 14A shows the time and displays a message indicating that no parking is allowed for the given time range. FIG. 14B shows how safety information or temporary status information may be displayed. FIG. 14C, FIG. 10D and FIG. 10E show how specific local information may be displayed.

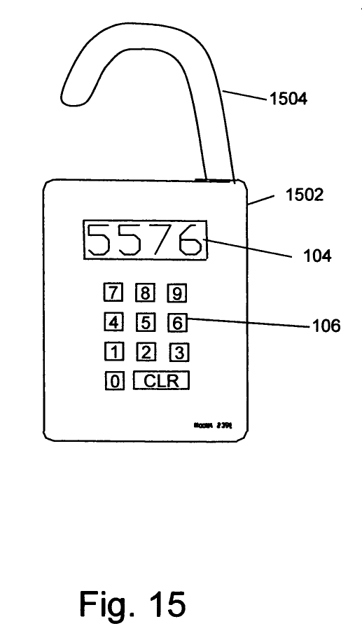

FIG. 15 illustrates the use of an in-car parking meter in accordance with the present invention. FIG. 15 shows a view of the in-car meter 1502 with the meter number shown on the display 104. The in-car parking meter is a device that may be hung on the rear view mirror, using the hanger1504 as shown, and registers parking time as a normal meter. The in-car meter may include a keypad 106 and/or a wireless interface, just as the curbside meter of FIG. 1. The functional block diagrams of FIGS. 2B and 2C also describe the curbside meter 1502 and associated system. The in-car parking meter is started in the same way as the curbside meter. The parking space will have an identification number. The user calls the server and gives the parking space number. The user may also give the meter ID, but alternatively the meter ID may be registered with the user cell phone number and need not be provided. The server then provides an enable code, which is then entered into the meter using the keypad (or automatically transferred using the wireless link, if provided). The meter then times the parking (also referred to as metering the parking time) and displays remaining parking time. When the user returns and wishes to terminate the parking time, the user calls the server and obtains a stop code, which is entered to stop the meter.

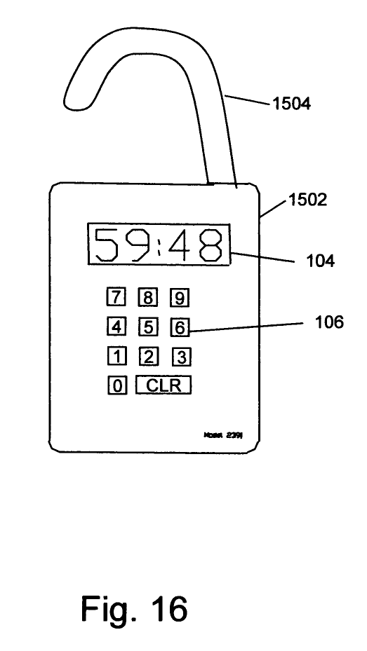

FIG. 16 shows a view of the in-car personal parking meter with the remaining parking time shown in the display 104. The meter number and parking time displays may alternate.

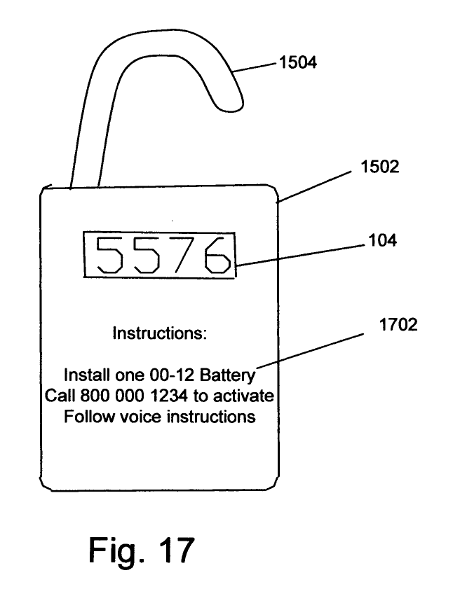

FIG. 17 is a rear view of the in-car personal parking meter showing battery installation and activation instructions 1702.

### Conclusion

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A parking meter comprising:
a parking meter identification for identifying the parking meter, said parking meter identification presented as a visual display of said parking meter identification on or near the parking meter;
means for entering an enabling code into the parking meter; and
means for delivering a service by the parking meter based on the entry of said enabling code into the parking meter;
wherein said parking meter identification is provided to a distant server over a cell phone external to said parking meter based on observation of said visual display of said parking meter identification; and
wherein said enabling code is provided by said distant server over said cell phone external to said parking meter for deliver to said parking meter, said enabling code generated based on said parking meter identification for said parking meter, said enabling code generated based on said parking meter identification for said parking meter.

2. The parking meter of claim 1, wherein the means for entering the enabling code comprises a keypad or a wireless link.

3. The parking meter of claim 2, wherein the wireless link is an infrared link, a BLUETOOTH® link, or a ZIGBEE® link.

4. The parking meter of claim 1 wherein the service is parking time.

5. (canceled)

6. (canceled)

7. The parking meter of claim 1, further including a plurality of enabling codes including said enabling code and a plurality of services including said service, each of said plurality of enabling codes associated with a corresponding service of said plurality of services; wherein said enabling code is used to select said service from said plurality of services.

8. The parking meter of claim 1, wherein the enabling code is different for each subsequent use of the parking meter.

9. The parking meter of claim 1, wherein the value of enabling code depend on time.

10. A parking meter system comprising:
a parking meter comprising:
a parking meter identification for identifying said parking meter, said a parking meter identification presented as a visual display of said parking meter identification on or near said parking meter;
means for entering an enabling code into said parking meter; and
means for delivering a service from said parking meter;
a central server comprising:
a telephone interface;
a database containing said parking meter identification and associated enabling code generation parameters for said parking meter; said enabling code generation parameters differing from a corresponding set of generation parameters for a different parking meter; and
an enabling code generator;
wherein the central server provides said enabling code over said telephone interface to a cell phone external to said parking meter for delivery of said enabling code to said parking meter in response to said central server receiving said parking meter identification over said telephone interface; said receiving of said parking meter identification based on observation of said visual display of said parking meter identification; enabling code generated by said enabling code generator based on said associated enabling code parameters obtained from said database in accordance with said parking meter identification; said parking meter delivering said service upon said delivery of said enabling code.

11. The parking meter system of claim 10, wherein the means for delivering said service comprises a display responsive to a clock for metering parking time and said service comprises metering said parking time.

12. The parking meter system of claim 10, wherein the means for entering said enabling code comprises a keypad or a wireless link.

13. The parking meter of claim 10, wherein the enabling code is different for each subsequent use of the parking meter.

14. The parking meter of claim 13, wherein the value of the enabling code depends on time.

15. A method for managing a parking space by a parking authority server comprising:
establishing an account with a patron;
receiving an identification from a cell phone said patron based on said patron reading a visual display of said identification located on or near a parking meter, said identification for identifying said parking meter, said parking meter associated with said parking space;
retrieving code generation information for said parking meter from a meter database based on said identification;
computing an enabling code for said parking meter using said code generation information;
sending said enabling code to said cell phone of said patron for said patron to
enter said enabling code in said meter to start said meter measuring parking time; and
billing said account for said parking time.

16. The method of claim 15, further including the steps of:
receiving a request to stop said meter from said patron;
generating a stop code responsive to said request; and
providing said stop code to said cell phone of said patron for entering by said patron in said meter to stop said meter measuring said parking time.

17. (canceled)

18. The method of claim 15, wherein said enabling code is based, at least in part, on time.

19. The method of claim 15, further including a plurality of parking meters, wherein said code generation information is different for each parking meter in said plurality of parking meters.

20. The method of claim 15, wherein said code generation information comprises a table of values.

21. The method of claim 15, further including the steps of: starting to measure said parking time at said meter based on said enabling code.

22. The method of claim 16, further including the steps of: receiving said stop code from said patron through keypad entry at said meter, and stopping measuring said parking time at said meter based on said stop code. receiving said enabling code from said patron through keypad entry at said meter, and
